(19) United States
(12) Patent Application Publication
(10) Pub. No.: US 2004/0109667 A1
(43) Pub. Date: Jun. 10, 2004

(54) Moving picture reproducing terminal

(76) Inventors: Masayuki Matsuda, Yokohama (JP); Susumu Kojima, Hitachinaka (JP); Shinichi Obata, Fujisawa (JP)

Correspondence Address: MCDERMOTT WILL & EMERY, 600 13TH STREET, N.W., WASHINGTON, DC, 20005-3096, US

(21) Appl. No.: 10/631,003

(22) Filed: Jul. 31, 2003

(30) Foreign Application Priority Data
Sep. 3, 2002 (JP) 2002-257400

(51) Int. Cl. H04N 11/00

(52) U.S. Cl. 386/37; 386/13

(57) ABSTRACT

A moving picture reproducing terminal is disclosed which allows reproduction of a moving picture content to be resumed from the current scene at which the process was stopped earlier. Where reproduction of the moving picture content having a specific name is stopped halfway, the result of the decoded content currently on display is stored in association with the specific content name and together with a time position of a current frame relative to the beginning of the content. When reproduction of the same moving picture content is to be resumed, the specific content name is retrieved from storage along with the result of the decoded content associated with that name and the relative time position, so that reproduction of the content is resumed exactly from the frame at which the process was stopped previously.

### BACKGROUND OF THE INVENTION

1. Field of the Invention

The present invention relates to a moving picture reproducing terminal capable of reproducing moving pictures. More specifically, the invention relates to a moving picture reproducing apparatus that holds in storage the relapsed time of moving picture reproduction up to a scene at which the reproduction is stopped, or both the relapsed time of moving picture reproduction up to a given scene and a result of decoded moving picture data in effect at that point in time, whereby the reproduction is resumed when desired from the scene where it was halted previously.

2. Description of the Related Art

Today, the moving picture reproducing techniques allow pictures and sounds to be recorded on, say, magnetic tapes of a VCR for subsequent playback, pause, fast forward or other operation. There also exists moving picture reproducing software for use with DVD players or personal computers whereby moving pictures are stored not physically but numerically in a memory such as DRAM. The numerically stored pictures are decoded by dedicated decoding software for reproduction either from the beginning of content or from a specific position counted in seconds relative to the beginning. In recent years, some moving picture reproducing terminals such as mobile telephones are equipped with communicating functions capable of reproducing moving picture data downloaded from a communication network.

Where the reproduction of moving picture data from the conventional videotape is stopped, the process may be resumed by simply restarting the tape run from the position at which it was halted. In the case of reproduction illustratively from a DVD, stopping the reproduction at a given scene and later resuming it there from is a somewhat complicated affair. More specifically, moving picture data are stored in compressed form on the DVD to reduce the quantity of stored information on the disc. A large number of frames called an I frame each and derived only from specifically encoded information are dispersed throughout the stored data. Any one of the I frames may have its time position, relative to the beginning of content, decoded and placed into storage at a point where reproduction is halted. When the process is later resumed, the stored relative time position is referenced to determine where to restart the reproduction (see Japanese Published Unexamined Patent Application No. Hei 8-205083 for example). Each I frame is formed by encoding the picture data specific to the frame in question. Predictive coding frames (P frames) other than the I frames are formed with stored data that encode the difference relative to each I frame on a screen. These arrangements are designed to boost compression rates of the moving picture data as a whole.

The above-mentioned moving picture reproducing terminal equipped with communicating functions is required to keep its data capacity reduced because of the need to connect with the communication network. That often means an entire collection of moving picture data downloaded by the terminal is headed only by a single I frame. In that case, if a moving picture reproduction process is halted halfway, it cannot be resumed from the stopped position using the same techniques as those for DVD players; the process must be repeated from the beginning. During reproduction of moving picture data lasting several minutes on the terminal, the process could be suspended due to an external event such as an incoming call. Then the reproduction must be repeated all over again even if the remaining process time is just a few seconds. This has been a major inconvenience to users of this type of terminal.

### SUMMARY OF THE INVENTION

With a view to improving on the above-outlined conventional moving picture reproducing terminal such as a mobile telephone with an insufficient ability to reproduce moving pictures, an object of the present invention is to provide a moving picture reproducing terminal capable of temporarily storing both a relative time position at which reproduction of moving picture content is stopped relative to the beginning of the content and the result of a decoded frame applicable to that position, whereby reproduction of the same content is resumed from the most recently stopped scene through the use of the relative time position and the result of the decoded frame in storage.

In carrying out the invention and according to one aspect thereof, there is provided a moving picture reproducing terminal comprising: a memory unit for storing a moving picture content in association with a specific name; a moving picture content decoding unit for reproducing the moving picture content stored in association with the specific name; a moving picture display unit for displaying decoded moving picture data; and a control unit for controlling the other units; wherein, during a first reproduction process of the moving picture content, a relative time position of the content at a given point in time relative to the beginning of the content is stored into the memory unit together with a result of the decoded moving picture data in effect at that point in time; and wherein, during a second reproduction process of the moving picture content, the control unit causes the moving picture content decoding unit to reproduce the moving picture content starting from the relative time position by use of the relative time position and the result of the decoded moving picture data retrieved from the memory unit.

### BRIEF DESCRIPTION OF THE DRAWINGS

Further objects and advantages of this invention will become apparent upon a reading of the following description and appended drawings in which:

FIGS. 1A and 1B are flowcharts of steps performed by a moving picture reproducing terminal practiced as a first embodiment of this invention whereby reproduction is stopped halfway and resumed where it was stopped earlier;

FIG. 2 is a block diagram of the first embodiment of the invention;

FIG. 3 is a schematic view of a first example of the data structure in a memory of the inventive moving picture reproducing terminal;

FIG. 4 is a block diagram of a moving picture reproducing terminal practiced as a second embodiment of this invention;

FIG. 5 is a schematic view of a second example of the data structure in the memory of the inventive moving picture reproducing terminal;

FIG. 6 is a flowchart of steps carried out by the second embodiment whereby reproduction is stopped halfway and resumed where it was stopped earlier;

FIG. 7 is schematic view of a partially updated data structure derived from what is shown in FIG. 5;

FIGS. 8A and 8B are flowcharts of steps performed by a moving picture reproducing terminal practiced as a third embodiment of this invention whereby reproduction is stopped halfway and resumed where it was stopped earlier;

FIG. 9 is a schematic view of a third example of the data structure in the memory of the inventive moving picture reproducing terminal;

FIG. 10 is a schematic view of a fourth example of the data structure in the memory of the inventive moving picture reproducing terminal; and

FIG. 11 is a plan view showing a transition of screens used for making a moving picture selection.

### DESCRIPTION OF THE PREFERRED EMBODIMENTS

Some preferred embodiments of this invention will now be descried with reference to the accompanying drawings.

As discussed above, where ongoing reproduction of moving picture data furnished with a single I frame per data item to minimize data size is stopped halfway, resumption of the process from the position it was stopped is implemented by obtaining a time difference of the stopped position relative to the most recently reproduced frame. If that kind of moving picture content being reproduced is halted halfway and the result of a decoded frame on display at that point in time is discarded, then it becomes impossible to resume the moving picture reproduction from the position at which it was most recently stopped. By contrast, if the moving picture content is compressed as described above so that the result of the decoded frame being displayed at the stopped point in time is stored together with the position of the frame relative to the beginning of the content, then referencing what is stored allows the reproduction to be resumed from the position at which it was halted earlier.

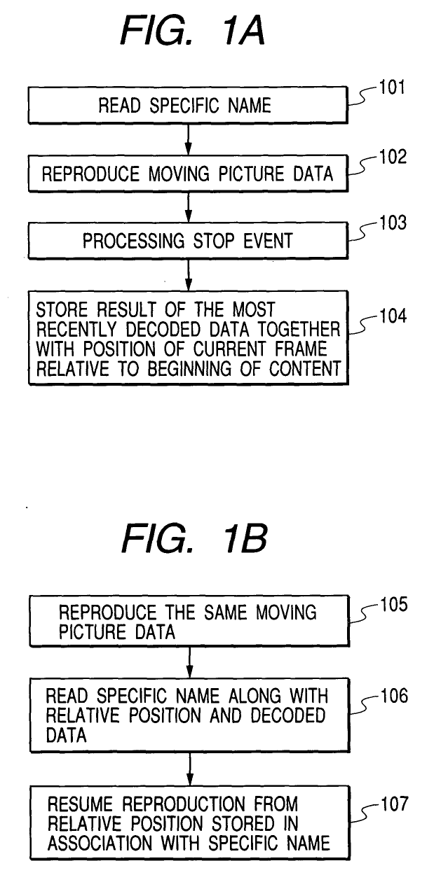

Described below with reference to FIGS. 1A through 3 is how the first embodiment of this invention solves the problem with the prior art of the moving picture reproduction being disabled from restarting at a halfway-stopped position.

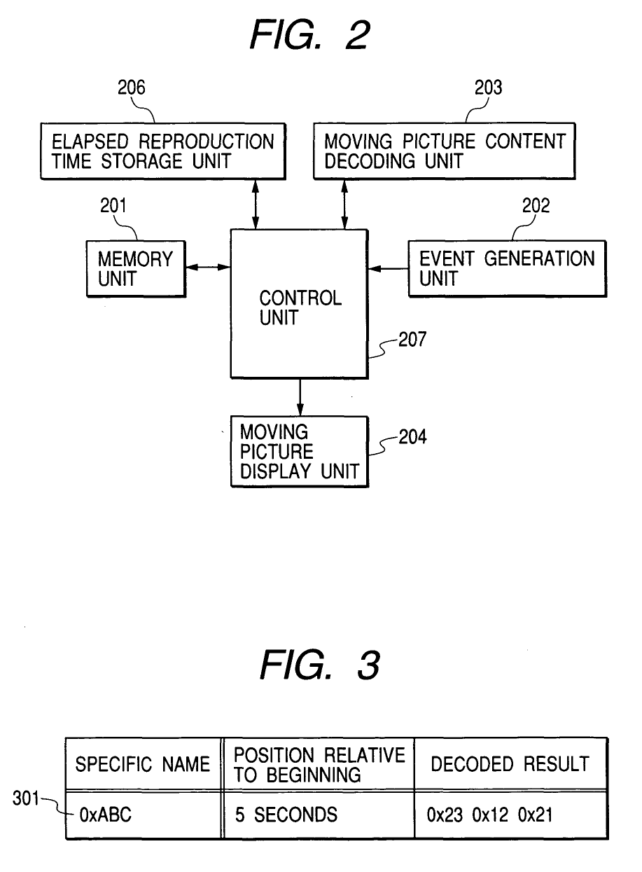

FIGS. 1A and 1B are flowcharts of steps performed by a moving picture reproducing terminal practiced as the first embodiment of this invention whereby reproduction is stopped halfway and resumed where it was stopped earlier. More specifically, FIG. 1A is a flowchart of steps in which reproduction is initiated and then stopped halfway, and FIG. 1B is a flowchart of steps whereby the reproduction is resumed from the halfway stopped position. FIG. 2 is a block diagram of the first embodiment of the invention. FIG. 3 is a schematic view of the first data structure example in the memory of the inventive moving picture reproducing terminal.

As shown in FIG. 2, the moving picture reproducing terminal practiced as the first embodiment of the invention includes: a memory unit 201 for storing a moving picture content associated with a specific name; an event generation unit 202 that generates events such as a start and a stop of moving picture reproduction; a moving picture content decoding unit 203 for decoding the moving picture content; a moving picture display unit 204; an elapsed reproduction time storage unit 206 that stores a time position of a given frame relative to the beginning of the content in question; and a control unit 207 for controlling these units.

How the reproduction process stopped halfway by a stop event is resumed by the terminal of FIG. 2 will now be described with reference to FIGS. 1A and 1B. In step 101 of FIG. 1A, a moving picture content stored in association with a specific name is retrieved from the memory unit 201. More specifically, the event generation unit 202 generates a moving picture reproduction start event regarding a specific name, which prompts the control unit 207 to retrieve the moving picture content having that name from storage. The retrieved content is handed over to the moving picture content decoding unit 203. In step 102, the moving picture content decoding unit 203 decodes the retrieved moving picture content. The decoded moving picture data are displayed on the moving picture display unit 204. In step 103, the event generation unit 202 generates a stop event causing control to be transferred to step 104. In step 104, the result of the decoded data currently on display is stored into the memory unit 201 in association with the specific name of the currently reproduced content. Concurrently, the relative time position of a frame in effect at the stopped point in time relative to the beginning of the content is placed into the elapsed reproduction time storage unit 206.

FIG. 3 schematically shows a typical data structure in which the time position of a given frame relative to the beginning of the content is stored in the elapsed reproduction time storage unit 206. In FIG. 3, reference numeral 301 denotes a moving picture content specifically named “0xABC.” If the elapsed reproduction time is five seconds, then the relative position to the beginning of the content is stored as five seconds, along with the result of decoded data representing a single screen on the moving picture display unit 204 in effect at that point in time.

The relative position to the beginning of the content may be either in seconds in which reproduction has lasted up to the stop event, or in frames that have been displayed up to that point in time. The result of the decoded data currently in effect needs to be stored here to enable the moving picture content decoding unit 203 subsequently to resume reproduction from where it stopped. A typical format in which to store the decoded result may involve retaining data in terms of brightness (Y signal) and color different signals (Cb and Cr components).

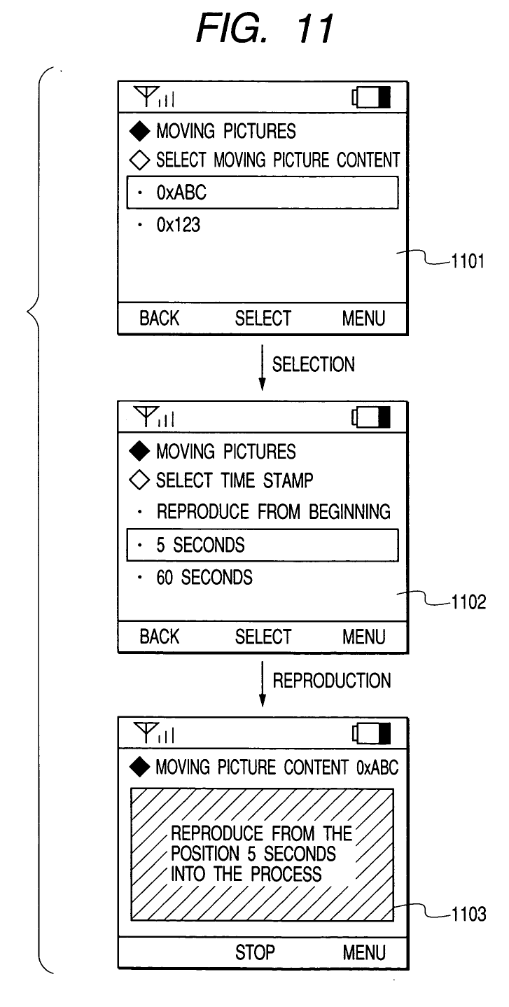

Suppose that the terminal of FIG. 2 has the specific name “0xABC” selected illustratively on a moving picture selection screen such as one shown in FIG. 11 (described later). In that case, step 105 of FIG. 1B is reached in which the event generation unit 202 requests reproduction of the same moving picture data. In step 106, the specific name is retrieved from the memory unit 201 together with the decoded result and the time position relative to the beginning of the content in association with the specific name in question. In step 107, the moving picture content decoding unit 203 resumes reproduction of the moving picture content by use of the decoded result thus retrieved along with the time position relative to the beginning of the content. This permits resumption of the moving picture reproduction. On moving picture content selection screens such as those shown in FIG. 11, each moving picture content whose current relative position is stored may be identified by a special marking such as a time-stamp indication, as opposed to the other contents with no such relative position recordings. The steps above enable the moving picture reproducing terminal to resume the reproduction process from the scene at which it was stopped earlier.

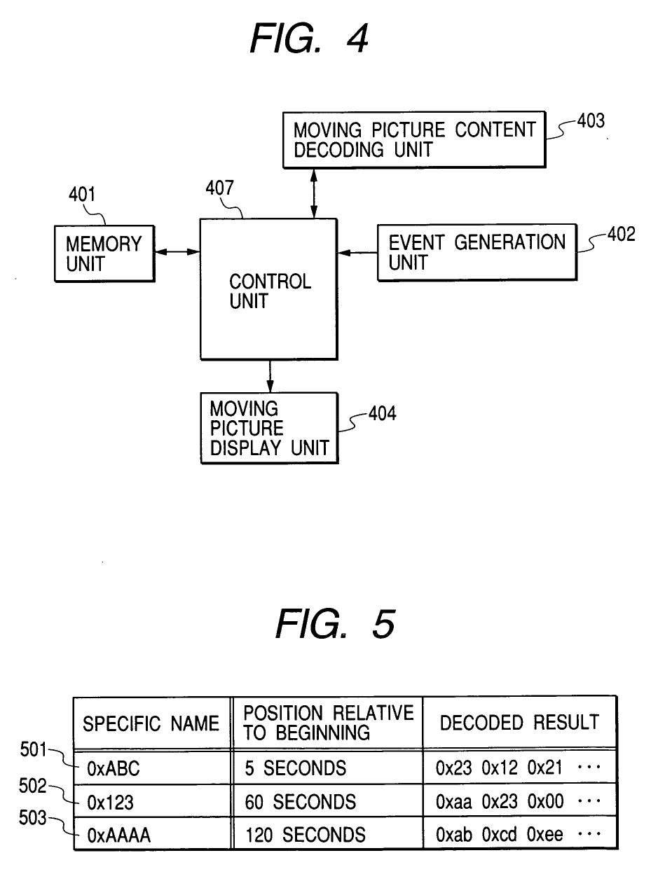

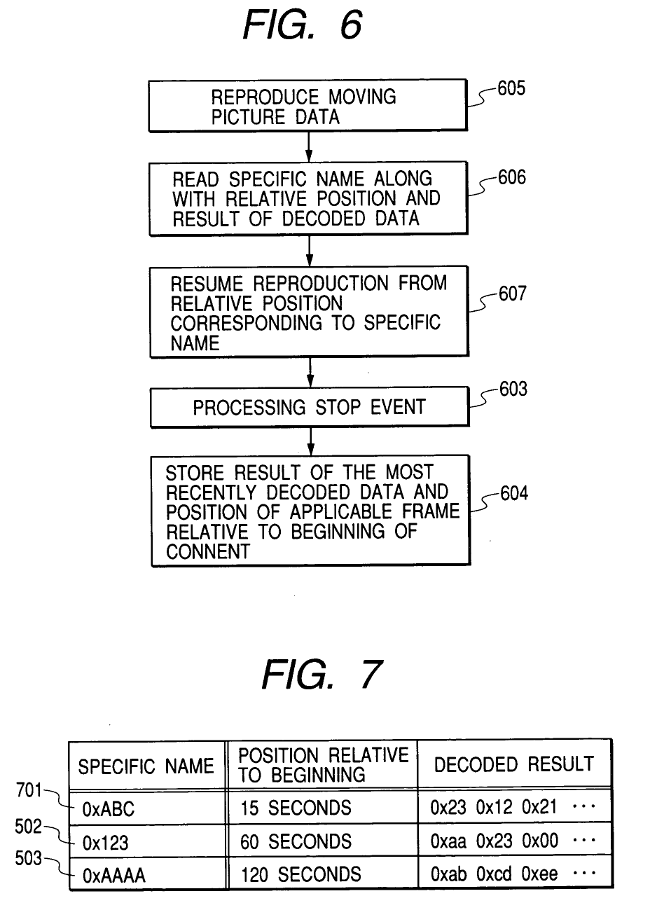

Described below with reference to FIGS. 4 through 7 is how the second embodiment of this invention reproduces any one of a plurality of moving picture contents based on updated relative position information. FIG. 4 is a block diagram of a moving picture reproducing terminal practiced as the second embodiment of this invention. FIG. 5 is a schematic view of the second data structure example in the memory of the inventive moving picture reproducing terminal. FIG. 6 is a flowchart of steps carried out by the second embodiment whereby reproduction is stopped halfway and resumed where it was stopped earlier. FIG. 7 is schematic view of a partially updated data structure derived from the example of FIG. 5.

Referring to FIG. 4, a memory unit 401 stores moving picture contents in association with a plurality of specific names listed in FIG. 5. The memory unit 401 also accommodates elapsed reproduction times of the contents in functionally taking over the elapsed reproduction time storage unit 206 shown in FIG. 2. An event generation unit 402 can be functionally similar to its counterpart shown in FIG. 2 in generating events such as a start and a stop of moving picture reproduction. Alternatively, the event generation unit 402 may generate only the event of starting moving picture reproduction. In this case, the event of stopping moving picture reproduction may be triggered by some other occurrences. Illustratively, if the moving picture reproducing terminal is equipped with communicating functions, an incoming call may be recognized as a moving picture reproduction stop event. In this particular instance, the flow of processing becomes the same as that described above in connection with the first embodiment of the invention with reference to FIGS. 1A and 1B.

With a plurality of moving picture contents stored in the memory unit 401 in FIG. 4 in association with a plurality of specific names, suppose now that a moving picture content 501 specifically named “0xABC” is stopped after five seconds of reproduction due to a stop event. At that point, the time position of five seconds relative to the beginning of the content is stored corresponding to the moving picture content 501 having the specific name “0xABC” in conjunction with the result of the currently decoded data. Likewise, if a moving picture content 502 with a specific name “0x123” and a moving picture content 503 specifically named “0xAAAA” are reproduced for 60 seconds and 120 seconds respectively before being stopped by a stop event each, the time positions of 60 seconds and 120 seconds relative to the beginnings of the respective contents are stored regarding the contents in association with the results of the currently decoded data.

Thereafter, as shown in step 105 of FIG. 1B, the moving picture content with the specific name “0xABC” may be requested to be reproduced. This causes control to be passed on to step 106 in which the time position of five seconds relative to the beginning of the content is retrieved together with the decoded data in effect at that point in time. In step 107, reproduction of the content named “0xABC” is resumed from the position where it was stopped earlier. If in step 105 the content named “0x123” (502) or “0xAAAA” (503) is requested to be reproduced, the respective relative time position of 60 or 120 seconds is retrieved together with the corresponding result of the decoded data, whereby reproduction of the moving content with the applicable specific name is resumed from the position where it was stopped earlier.

It is assumed here that the second embodiment is capable of updating relative time positions of stored contents relative to the beginnings thereof. In this case, steps 105, 106 and 107 discussed above with reference to FIG. 1B are replaced by steps 605, 606 and 607 in FIG. 6 respectively.

In step 605, reproduction of the same moving picture content is requested by the event generation unit 402. In step 606, the moving picture content 501 with the specific name “0xABC” is retrieved from the memory unit 401 along with the result of the decoded data corresponding to the specific name and the time position of five seconds relative to the beginning of the content in question. In step 607, reproduction of the moving picture content 501 with the specific name “0xABC” is resumed from the relative time position of five seconds. Another stop event may occur during the reproduction, as in step 603. In that case, step 604 is reached in which the relative time position of the frame in effect at that point in time relative to the beginning of the content i updated. Suppose that reproduction of the content lasts 10 seconds starting from the relative time position of five seconds before getting stopped a second time in step 603. Then the relative time position of the moving picture content 501 is updated from five seconds to 15 seconds relative to the beginning of the content, as shown in FIG. 7. It should be noted that the relative time positions of the other specifically named moving picture contents as well as their decoded results remain unchanged as shown in FIG. 7.

As described, the second embodiment of this invention is designed to hold recordings of the stop events regarding a plurality of moving picture contents so that any one of the contents may be reproduced from the most recently stopped position. Regardless of the many contents being stored for extended reproduction times, the inventive moving picture reproducing terminal eliminates reproduction time redundancies by allowing each of the contents to be resumed exactly where it was stopped earlier in reproduction. With its ability to update the elapsed reproduction times following reproduction processes, the moving picture reproducing terminal proves to be more convenient to the user than before.

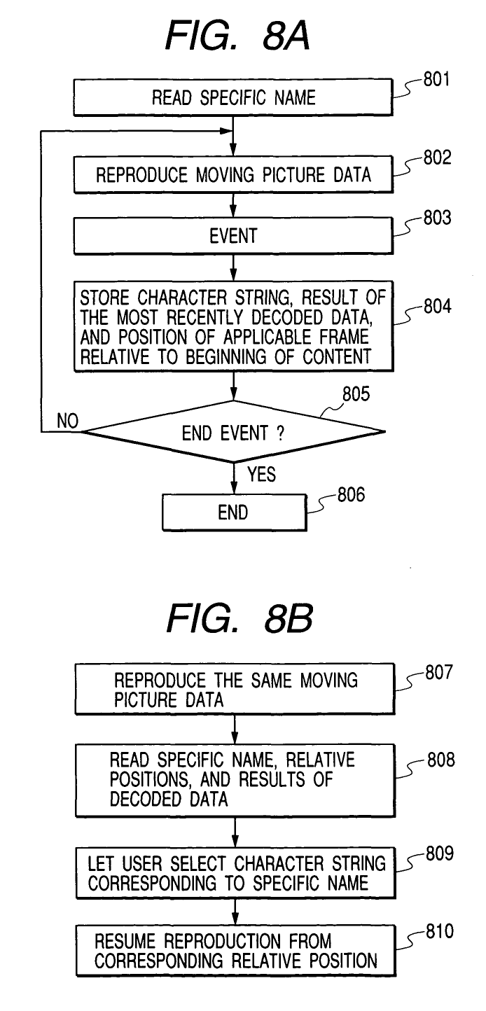

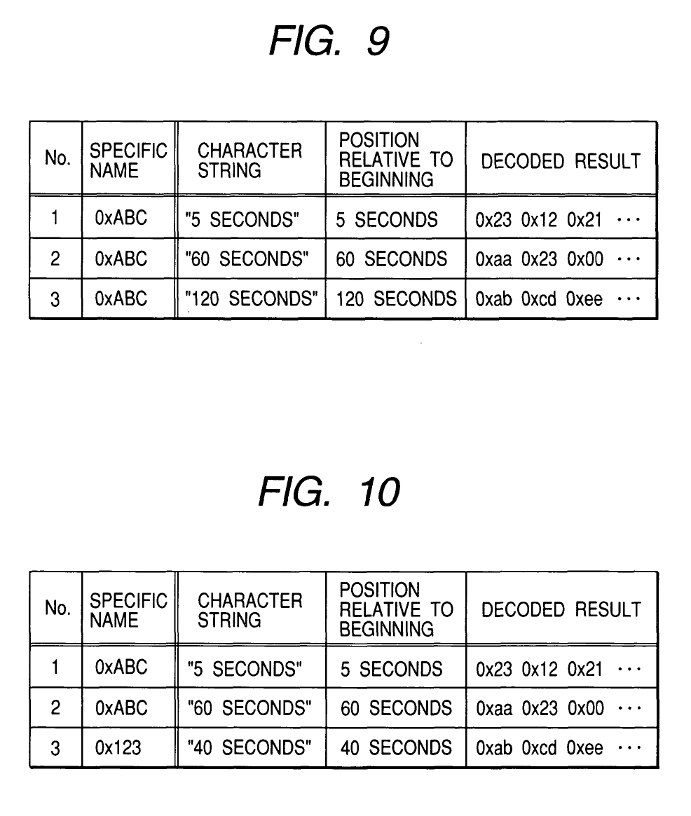

Described below with reference to FIGS. 8A, 8B and 9 is how the third embodiment of this invention stores a plurality of time positions of a specifically named content relative to the beginning thereof depending on the types of events occurring halfway through content reproduction, so that any one of the multiple relative time positions may be selected for resumption of the reproduction process from the desired position.

FIGS. 8A and 8B are flowcharts of steps performed by a moving picture reproducing terminal practiced as the third embodiment of this invention whereby reproduction is stopped halfway and resumed where it was stopped earlier. More specifically, FIG. 8A is a flowchart of steps whereby the ongoing reproduction is stopped halfway, and FIG. 8B is a flowchart of steps whereby the halfway-stopped reproduction process is resumed from the position where it was stopped. FIG. 9 is a schematic view of the third data structure example in the memory of the inventive moving picture reproducing terminal.

The block structure of the third embodiment is basically the same as that in FIG. 2 or 4, except for some modifications in the elapsed reproduction time storage unit 26 or memory unit 401. As shown in FIG. 9, the elapsed reproduction time storage unit 26 or memory unit 401 is designed to associate a single specific name with a plurality of character strings, a plurality of time positions relative to the beginning of the content having that specific name, and a plurality of results of decoded data in effect at these positions.

When a moving picture reproduction start event occurs, step 801 of FIG. 8A is reached in which the moving picture content specifically named “0xABC” is retrieved. In step 802, the moving picture content stored in association with the specific name is reproduced. In step 803, an event occurs which causes the current position to be stored. In response to the event, step 804 is reached in which the corresponding character string (in seconds in this example) is retrieved along with the most recently decoded data and the time position of the frame in effect relative to the beginning of the content. In FIG. 9, Nos. 1, 2 and 3 denote tabular rows each including the same moving picture content with the specific name “0xABC.” In the row No. 1 of FIG. 9, the elapsed reproduction time storage unit 206 or memory unit 401 records a character string of “5 seconds” indicating that the moving picture content named “0xABC” was reproduced five seconds before being stopped, hence the relative position of “5 seconds” stored at the stopped position relative to the beginning of the content, along with the result of the decoded data applicable to the stopped position. Likewise the tabular row No. 2 is associated with a character string of “60 seconds” indicating that the moving picture content named “0xABC” was reproduced 60 seconds before being stopped, hence the relative position of “60 seconds” stored at the stopped position relative to the beginning of the content, together with the result of the decoded data applicable to the stopped position; and the tabular row No. 3 corresponds to a character string of “120 seconds” indicating that the moving picture content named “0xABC” was reproduced 120 seconds before being stopped, hence the relative position of “120 seconds” stored at the stopped position relative to the beginning of the content, along with the result of the decoded data applicable to the stopped position. This is how the elapsed reproduction time storage unit 206 or memory unit 401 stores a single specific name of “0xABC” numbered 1, 2 and 3 separately to be associated with the following: multiple character strings indicating elapsed reproduction times prior to a stop event each; relative time positions of the frames in effect at the stopped positions relative to the beginning of the content; and results of the most recently decoded data applicable to the stopped positions.

In step 805 of FIG. 8A, the type of an event is verified. There may be a primary interruption event, an end event, or a time-stamp storing event. In the case of an end event, the reproduction process is terminated in step 806. If the event turns out to be anything other than the end event in step 805, step 802 is reached again and reproduction of the moving picture content is continued. If in step 803 an event again occurs which causes the current position to be stored, step 804 is reached in which the character string “60 seconds” (No. 2 in FIG. 9) is stored along with the result of the most recently decoded data and the time position in effect at that point in time relative to the beginning of the content. FIG. 9 shows that the event causing the current position to be recorded took place five seconds, 60 seconds, and 120 seconds into reproduction of the moving picture content with the specific name “0xABC.” Alternatively, a special button may be provided allowing the user to generate a current position recording event whenever desired.

In step 807, reproduction of the same moving picture data is requested. In that case, step 808 is reached in which the specific name “0xABC” is retrieved. In step 809, the user is allowed to select any one of the character strings being stored corresponding to the specific name in question. In the table of FIG. 9, the rows No. 1 through No. 3 show that the content with the name “0xABC” was stopped five seconds, 60 seconds, and 120 seconds into the reproduction process. The user has one of three character strings to choose from: “5 seconds,” “60 seconds” or “120 seconds.” Alternatively, character strings such as “5 seconds” may not be stored corresponding to the specific name in step 804 but may be generated immediately before step 809 as the desired time positions relative to the beginning of the content.

After any one of the stored character strings is selected, step 810 is reached in which the reproduction process is resumed from the corresponding time position in the designated seconds relative to the beginning of the content. It is also possible to set as a default start position the beginning of the moving picture content with the specific name “0xABC.” This is one more alternative that may be chosen by the user for reproduction of the content after it was stopped halfway.

As described, the moving picture reproducing terminal practiced as the third embodiment of the invention allows the user to select any one of a plurality of previously established time positions relative to the beginning of a moving picture content that may take long to reproduce. The third embodiment thus provides further convenience to the user.

A typical transition of screens applicable to the feature of the third embodiment will now be described with reference to FIGS. 10 and 11. FIG. 10 is a schematic view of the fourth data structure example in the memory of the inventive moving picture reproducing terminal. FIG. 11 is a plan view showing a transition of screens used for making a moving picture selection.

As shown in FIG. 10, it is assumed that the memory holds the following: a character string of “5 seconds” in tabular row No. 1 indicating that a moving picture content specifically named “0xABC” was reproduced five seconds before being stopped, hence the time position of five seconds relative to the beginning of the content, along with the result of decoded data in effect at that point in time; tabular row No. 2 including a character string of “60 seconds” indicating that the same content with the same name was reproduced 60 seconds before being stopped, hence the time position of 60 seconds relative to the beginning of the content, together with the result of decoded data in effect at that point in time; and tabular row No. 3 including a character string of “40 seconds” indicating that another moving picture content with a different specific name “0x123” was reproduced 40 before being stopped, hence the time position of 40 seconds relative to the beginning of the content, along with the result of decoded data in effect at that point in time.

Referring to FIG. 11, a screen 1101 is activated for selecting a desired moving picture content to be reproduced from a previously stopped position. Suppose now that the content named “0xABC” is selected from among candidate moving picture contents. The selection prompts a screen 1102 to appear allowing the use to choose from three alternatives: “reproduce from beginning,” “5 seconds” and “60 seconds” as illustrated. If the content named “0x123” is selected on the screen 1101, the user is offered two choices: “reproduce from beginning” and “40 seconds.” When the user selects one of the alternatives on the screen 1102, the previously stored time position relative to the beginning of the content is retrieved along with the result of the decoded data in effect at that point in time. If the character string “5 seconds” is selected on the screen 1102, then the time position of five seconds relative to the beginning of the content is retrieved together with the result of the applicable decoded data, whereby reproduction of the content is resumed from the position five seconds into the process. If “reproduce from beginning” is selected, then none of the data shown in FIG. 10 is retrieved and the content is reproduced from the beginning.

The above feature is activated or deactivated as desired by specifying whether or not to store the time positions relative to the beginning of the content into the memory unit 201 in FIG. 2 or memory unit 401 in FIG. 4. The moving picture reproducing terminal checks to see whether the relative time positions are set to be stored at a current position storing event (in step 103, 503 or 803) or upon reproduction of moving picture data (in step 105, 605 or 807) in the above-described flow of processing. The result of the check causes the terminal to reproduce the moving picture content either from any one of a plurality of previously established relative time positions or from the beginning of the content as has been done conventionally.

Whether to store the time positions of a content relative to the beginning thereof may be specified either for all moving picture contents in the moving picture reproducing terminal or for any given specific content name held in the memory unit.

If desired, only the reproduction from the beginning of the content may be set to be stored at the time of the above-described current position storing event. As a variation of this alternative, if reproduction of the same moving picture content is to be resumed after it was stopped halfway, it is possible to retrieve only the relative time positions from storage, obtain the I frame closest to the corresponding time position, and resume the reproduction process from that I frame obtained. Where a large number of I frames are inserted throughout contents such as those of DVDs, this feature eliminates the need for retaining the results of decoded data in effect at halfway-stopped positions and thereby contributes to reducing the memory size.

According to the invention, when reproduction of a moving picture content is stopped halfway and later resumed from the halfway-stopped position, reproduction time redundancies characteristic of conventional terminals are eliminated, and the reproduction process is resumed exactly where it was stopped earlier.

The inventive terminal permits storage of a plurality of time positions of a single moving picture content relative to the beginning thereof, so that the user is offered a number of points at which to resume the reproduction process. The moving picture reproducing terminal of this invention thus proves to be more convenient to users than ever before.

As many apparently different embodiments of this invention may be made without departing from the spirit and scope thereof, it is to be understood that the invention is not limited to the specific embodiments thereof except as defined in the appended claims.

What is claimed is:

1. A moving picture reproducing terminal comprising:
a memory unit for storing a moving picture content in association with a specific name;
a moving picture content decoding unit for reproducing said moving picture content stored in association with said specific name;
a moving picture display unit for displaying decoded moving picture data; and
a control unit for controlling the other units;
wherein, during a first reproduction process of said moving picture content, a relative time position of the content at a given point in time relative to the beginning of said content is stored into said memory unit together with a result of the decoded moving picture data in effect at said point in time; and
wherein, during a second reproduction process of said moving picture content, said control unit causes said moving picture content decoding unit to reproduce said moving picture content starting from said relative time position by use of said relative time position and said result of said decoded moving picture data retrieved from said memory unit.

2. A moving picture reproducing terminal according to claim 1, wherein said relative time position of said content at said point in time relative to the beginning of said content is stored together with said result of said decoded moving picture data in effect at said point in time in association with each of a plurality of specific names given to a plurality of moving picture contents, so that during said second reproduction process, any one of said moving picture contents is reproduced starting from said relative time position.

3. A moving picture reproducing terminal according to claim 1, wherein it is possible to specify for said specific name whether or not to store said relative time position of said content at said point in time relative to the beginning of said content together with said result of said decoded moving picture data in effect at said point in time; and
wherein the specification is stored into said memory so that during said second reproduction process of said moving picture content, said relative time position of said content at said point in time relative to the beginning of said content and said result of said decoded moving picture data are stored differently depending on said specification in said storage unit.

4. A moving picture reproducing terminal comprising:
a memory unit for storing a moving picture content in association with a single specific name;
a moving picture content decoding unit for reproducing said moving picture content stored in association with said single specific name;
a moving picture display unit for displaying decoded moving picture data; and
a control unit for controlling the other units;
wherein, during a first reproduction process of said moving picture content, said single specific name is associated with a plurality of relative time positions of the content at a plurality of points in time relative to the beginning of said content when stored into said memory unit together with a result of the decoded moving picture data in effect at each of said points in time; and
wherein, during a second reproduction process of said moving picture content, any one of said plurality of relative time positions is selected so that said control unit causes said moving picture content decoding unit to reproduce said moving picture content starting from the selected relative time position by use of said selected relative time position and the result of said decoded moving picture data which corresponds to said selected relative position.

5. A moving picture reproducing terminal according to claim 4, wherein it is possible to specify for said single specific name whether or not to store said relative time positions of said content at said points in time relative to the beginning of said content together with said result of said decoded moving picture data in effect at each of said points in time; and
wherein the specification is stored into said memory so that during said second reproduction process of said moving picture content, said relative time positions of said content at said points in time relative to the beginning of said content and said result of said decoded moving picture data are stored differently depending on said specification in said storage unit.
